(19) United States
(12) Patent Application Publication
(10) Pub. No.: US 2009/0159642 A1
(43) Pub. Date: Jun. 25, 2009

(54) Process of Brazing/Soldering By Flame of Metallic and Non-Metallic Materials

(76) Inventors: Dennis J. Klein, Clearwater, FL (US); Corneliu Dica, Constanta (RO); Cristian Georgescu, Bucuresti (RO); Cristian Pamfilie, Bucuresti (RO); Mihai Teodorescu, Bucuresti (RO)

Correspondence Address: DENNIS G. LAPOINTE;LAPOINTE LAW GROUP, PL, PO BOX 1294, TARPON SPRINGS, FL, 34688-1294, US

(21) Appl. No.: 12/307,409

(22) PCT Filed: Jul. 26, 2007
(86) PCT No.: PCT/RO2007/000012

§ 371 Date: Jan. 5, 2009

(30) Foreign Application Priority Data
Jul. 28, 2006 (RO) A 2006 00605

(51) Int. Cl. B23K 1/012

(52) U.S. Cl. 228/101

(57) ABSTRACT

The invention refers to the flame soldering/brazing procedure of metallic and nonmetallic materials, used in industrial operations without releasing of noxious gases emissions. The soldering/brazing procedure according to the invention is achieved totally eliminating the noxious gases emissions, reducing the energy consumption for the soldering/brazing operation, and improving the quality of the joints by eliminating the influence of the temperature on the joint materials, in the following stages: cleaning and pickling of the joining surfaces with soldering/brazing flux, adapted as type and method to the specification of the materials that make up the joint; preparation and positioning of the joining components according to the joining drawing and ensuring a correct joint gap in relation to the added metal; uniform heating or the joint until the soldering/brazing alloy melted with the help of a burner with HHO oxy-hydrogen gas at a pressure of 0.1÷0.3 MPa; cooling of the joint with air and its protection so that it is not moved or stricken during the cooling and solidification of the soldering/brazing alloy.

### RELATED APPLICATIONS

This application is a 35 USC 371 national stage application of international application PCT/RO2007/000012 filed 26 Jul. 2007, which claims priority from Romania application a 2006 00605 filed 28 Jul. 2006.

The invention refers to a thermal brazing/soldering for metallic and/or non-metallic materials that can be used in industrial thermal brazing/soldering operations, and no noxious gases would be issued.

For the past decade, the attempt to identify and promote, at an industrial scale, some alternative energy sources as against fossil fuels, as well as to cut down industrial process related emissions has been approached at the level of its real importance. The proof of it consists in the interest granted, to the numerous energy related problems, by the research departments of the most famous institutions in the world, which led to an unprecedented concentration of the efforts towards the efforts to get to an industrial exploitation of the energy natural sources, and more than that, to promote hydrogen as an alternative energy source.

New concepts and studies, such as towards the management of noxious gases and the co-generation related to the energy production and consumption, are meant to draw the attention towards the necessity to intensify the research activity with a purpose to optimize the industrial processes and to minimize the impact the present technology has on environment.

Among these studies, the obtaining of a non-polluting gas to be used at an industrial level has been given a major attention. Henceforth, there has been obtained an oxy-hydrogen gas that is known further to the U.S. Pat. No. 6,689,259 B1 patent, as well as to the international request published under number WO2005076767 A3, both of them having the same author—Mr. Dennis J. KLEIN. This gas has been obtained by the controlled dissociation of an alkaline aqueous solution. This gas, further on referred to as the HHO oxy-hydrogen gas, is a mixture of 63 . . . 67% hydrogen and 30 . . . 35% oxygen, resulting from the water electrolysis reaction. The special qualities of this gas are a result of its capability to have a warm reaction while in contact with materials, irrespective of their nature, which justifies the effort to promote this gas with reference to industrial applications.

The oxy-hydrogen gas HHO obtained according to U.S. Pat. No. 6,689,259 B1 through controlled dissociation in electromagnetic field of an aqueous alkali liquor can be placed in the group of oxy-hydrogen gases. Yet it must be noted that the previous techniques of conducting the process of water electrolysis, of collecting and preparation of gas were only able to provide hydrogen and oxygen, separately or in a mix, in small volumes and at a low pressure (the U.S. Pat. No. 5,628,885 patent, having Mr. Yang C. Lin as the author; the U.S. Pat. No. 5,409,371 patent, having Mr. Arnold Z. Gordon as the author; the U.S. Pat. No. 5,407,348 patent, having Mr. Carl W. Minsa and Mr. Roger D. Zwicker as the authors, and the U.S. Pat. No. 4,014,777 patent, having Mr. Yull Brown as the author). As a consequence to the above, the use of the oxy-hydrogen obtained by applying the procedures stipulated by these patents has not had the development that would have been expected to the extent of the possibilities they offer with reference to the cutting, soldering and welding operations, as the applications limit to the manufacturing operation status, as sole product or small series product.

Nowadays, the brazing/soldering and the related procedures are, practically, omni-present in the industrial technological fluxes. From the numerous known and industrially applied processes, the interest for productivity has made the attention of the specialists turn, first of all, toward the processes based on using conventional heating sources, based on usage of fossil fuel.

As of the present period, there are being known and applied at an industrial level different soldering processes of some components of metallic or non-metallic materials (Witterbrood, A, s.a. Vacuum brazing: effect of oxide conditions on brazeability, “Vehicule Thermal Management Systems” Indianapolis, USA, 19-27^{th} of May 1997; ZORC, B. Application of reinforcement to improve properties of brazed joints. IIW DOC. IA. 1026-98; BACH, F. W. Praxis oriented development of brazing tool steels, PROCEEDINGS, 5^{th} International Conference, Aachen, 16-18 Jun. 1998; Benea, F., Secosan, I., Bar, F., Chiriac, A., Researches on the thermal behaviour of the fluxes intended for brass brazing with silver alloys, In: Annals of West University of Timisoara, Series of Chemistry, vol. VIII (1), 1999, pg. 63; Rabinkin, A.: Brazing stainless steel using a new MBF-series of Ni—Cr—B—Si amorphous brazing foils, IIW, DOC. 1A-10141997).

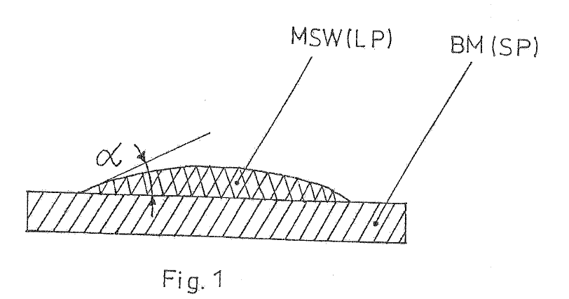

The brazing/soldering represents the operation through which there is achieved a permanent, heterogeneous joint of some components of metallic or non-metallic materials by means of a brazing/soldering alloy which, through melting, wets the base materials which do not participate through melting at the joint formation. The brazing/soldering alloy is obtained as a result of the displacement of the melted soldering alloy (liquid phase—LP) in the capillary joint (r) between the base materials (BM) (solid phase—SP) and the formation between them of a stable joint once the alloy has solidified. A good capacity to wet the base materials (BM) by the melted soldering alloy represents the main condition in order to obtain a quality soldered joint. In the theoretical study of wetting and displacing the melted soldering alloy (LP) in the joint between the base materials (SP) the chemical processes are ignored and only the superficial voltage (σ) and the viscosity factor (ν) of the melted soldering alloy are taken into consideration. In these conditions, at the joints soldered in plane horizontal capillary of r size, the pressure difference (pressure drop) Δp=2σ. Cos α/r at the phase surface of separation determines moisture (displacement) on BM of the melted soldering alloy. The displacement (radius) d of the soldering alloy (LP) in the plane capillary joint is given by the relation (1): d=r/2 cos α (α—moisture angle). At the joints soldered in vertical capillary joints, when the pressure difference (pressure drop) Δp=0, the moisture (lifting height) h of the melted soldering alloy in the vertical capillary joint (r) is maximum and is given by the relation (2): h=2σ·cos α/ρgr (ρ—the consistency of the alloy, g—gravity acceleration, r—the gap of the joint). As a result of relations 1 and 2 emerges the fact that the wetting of the base material by the melted soldering alloy (MSW) is determined by the value of the moisture angle α, as it is shown in FIG. 1.

From the analysis of the mentioned relations, in case of a certain brazing/soldering alloy, the following cases stand out:

α<90°—the melted brazing/soldering alloy (MSW) wets BM, flows into the capillary gap r and it is possible to obtain the sweated joint.
α>90°—the meted brazing/soldering alloy (MSW) does not wet BM, is pushed outside the capillary gap r and therefore the sweated joint is not obtained.
α=0—the brazing/soldering alloy wets BM to the maximum, the flow through the capillary gap (Horizontal, vertical) will be maximum and therefore the conditions of obtaining the sweated joint are optimum.

To favor the realization of the sweated joint, the brazing/soldering alloys are used with caustic flows. The caustic flows represent chemical compounds mixtures and, among other things, they are destined to change the inter phase energy at the border of the solid phase (BM) and liquid phase (MSW) with the purpose of decreasing the moisture angle α and to facilitate the flow of the soldering alloy in the gap.

The permanent joint through brazing/soldering of some components can be achieved at lower or higher temperatures than 450° C. Depending on the melting temperature of the alloy used at the achievement of the joint, we distinguish: soldering and brazing. At soldering, the soldering alloy has the melting temperature lower than 450° C., whereas at brazing, the melting temperature of the soldering alloy is at least 450° C.

The soldering/brazing flame processes known and promoted at the present time, more specifically by flame from a mixture of oxygen and different fuel gases, is accompanied by an important energy consumption, as well as the emission of some noxious gases which, from the point of view of quantity and risk level, are all the more important as the energy generated in the soldering/braying process is greater. As nature, the main noxious gases generated through the soldering/brazing processes by oxy-gas flame are metal vapors, carbon and sulphur oxides, radiations from the ultraviolet range and the noise. Due to the high temperature of the oxy-gas flame, the achieving of the soldering/brazing operation is almost impossible without overheating the base materials from the joint, which determines the alteration of the structure and its performances. The soldering/brazing through another known process by flame, meaning with oxy-hydrogen flame, although superior from the viewpoint of quality to the processes presented before, could not surpass the phase of manufacturing applications because it is lacking in overall efficiency.

The technical problem the present invention resolves consists of finding an oxy-hydrogen gas product capable of being used, in conditions of controlled burning, at soldering/brazing metallic and non-metallic materials, instead of the techniques based on using the energy of the fuel gases rich in carbon. Therefore, the problem that arose was that of developing an ecological process of soldering/brazing for metallic materials of all natures, for example with copper, silver, aluminum, iron base but also for non-metallic materials such as ceramic materials, a process that would not generate noxious gases and that could be efficiently promoted in industrial applications for obtaining sweated joints, with different forms and dimensions. Such a process was supposed to be competitive in comparison to known soldering/brazing processes, both from the viewpoint of the quality of the joints, as well as from the viewpoint of the economical efficiency of the soldering/brazing operations.

The ecological soldering/brazing process by flame of metallic and non metallic materials of all natures and sort-type-dimension, according to the invention, states the following conditions and succession of phases:
the cleaning of the soldering/brazing surfaces with soldering flow, adapted as type and application method to the specific of the materials that achieve the junction; the preparing and positioning of the components to be jointed according to the junction sketch and ensuring a joint gap appropriate to the quality of the filler metal, for example max. 0.12 mm in the case of the soldering/brazing alloys with silver or aluminum base;
the uniform heating of the junction until the melting of the soldering/brazing alloy with the aid of a flame blast-lamp of HHO oxy-hydrogen gas at a pressure of 0.1÷0.3 MPa, with a nozzle with a diameter adapted to the dimensions of the junction, for example 1.0 mm in the case of junctions with an overlapping length of up to 10 mm;
cooling of junction in still air and its protection in order not to be displaced or hit during the solidification and cooling of the soldering/brazing alloy.

The soldering/brazing process with HHO oxy-hydrogen gas according to the present invention satisfies the requirements of solving the problem as follows:
allows the achievement of sweated joints between components from any kind of materials—metallic or non metallic—without noxious gas emission throughout the entire soldering/brazing process;
ensures a superior quality of sweated joints and an high economical efficiency of the soldering/brazing process through the fact that it limits the energy application in the soldering/brazing process at the minimum level necessary for the melting of the soldering/braying alloy, which reduces to an insignificant level the thermal influence on the base materials of the components that form the junction and it allows the decrease to minimum of the duration of the soldering/brazing process.

Using the HHO oxy-hydrogen gas to the ecological soldering/brazing by flame is based on the special qualities of this gas which, when burning in the atmosphere, reaches a temperature of approximately 175° C. but, in the contact area of its flame with the soldering/brazing alloy, it determines a local increase in temperature to the melting temperature of the soldering alloy. The natural limitation of the temperature of the melt to the value inherent to the alloy in contact with the flame allows the use of the HHO oxy-hydrogen gas at the soldering/brazing of many categories of materials, metallic or nonmetallic.

The interaction of the flame of the HHO oxy-hydrogen gas with the soldering/brazing alloy present in the junction area reduces the duration of heating of the weld until melting, minimizes the risk of overheating the base materials from the junction and drastically reduces the energy consumption and the noxious gas emission, in comparison to the levels characteristic to soldering/brazing processes by oxy-gas flame.

The process with flame of the metallic and non metallic materials, according to the invention, has the following advantages:
it drastically reduces the quantity of noxious gases generated during the soldering/brazing process, in comparison to the oxy-gas process;
reduces the total consumption of energy in the soldering/brazing operation, in comparison with the oxy-gas process;
it intensifies the heating and melting process of the alloys used as soldering/brazing admixture and it improves the quality of the sweated joints by limiting the risk of overheating of the base materials in the junction.

Further, there are given more examples of application of the invention, regarding the figures which represent:

FIG. 1.—is a depiction of the moisture angle at soldering/brazing;
MSW—brazing/soldering alloy;
BM—base material.

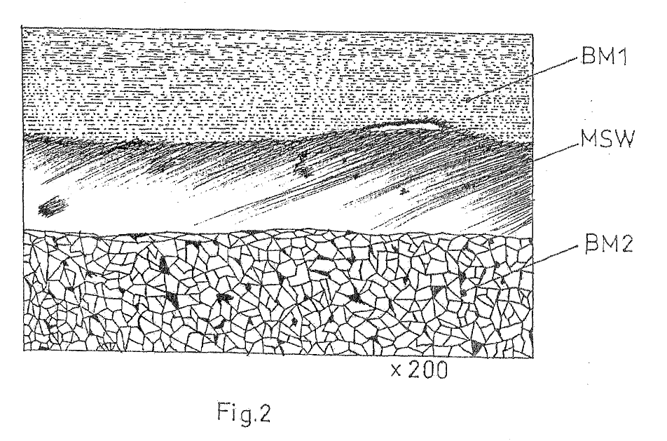

FIG. 2.—is a depiction of the section in the junction achieved by brazing with HHO oxy-hydrogen gas
MSW—brazing/soldering alloy (Ag49MnNi SR EN 1044);
BM 1—base material 1 (ceramic plate);
BM 2—base material 2 (carbon steel).

### EXAMPLE 1

### Soldering/Brazing Through the Oxy-Hydrogen Gas HHO Process of Some Flat Products from Aluminum Alloys and of Some Tubular Products from Copper Alloys

The process according to the invention was applied to the achievement of junctions through brazing according to the conditions imposed by SR EN 13134 and ASME Code Sect IX, as follows:
Execution in the horizontal position corresponding to the PA indicative from PT CR 7/1-2003 regarding junctions between the following sets of flat products:
   plate 100×10×0.5 mm from stainless steel X5CrNi18.10 according to SR EN 10028-7;
   plate ½t 1.5×10×80 from aluminum Al99.5 according to STAS 7607;
   plate ½t 1×6×34 from cooper alloy mark CuSn6 according to STAS 93;
   band 1.5×6 from silver Ag 99.9 according to STAS 3321.
Execution in the vertical position corresponding to the PG indicative from PT CR 7/1-2003 regarding junctions between the following sets of tubular products:
   pipe 1.2t 10×1.5 from aluminum Al 99.5 according to STAS 7607;
   pipe ½t 9×1 from copper alloy CuZn37 according to STAS 95;
   pipe ½t 9×2 from copper alloy CuZn37 according to STAS 95;
   pipe Ø9×1 from copper Cu99.5 according to STAS 270.

The brazing technique was manual and it was realized in the following succession of operations:

a) The Cleaning of the Surfaces of the Base Materials Before the Brazing Process.

This operation ensures the surfaces of the base materials are free of grease and rust, in order to obtain sweated joints of good and constant quality. The cleaning before soldering should be done through chemical methods such as:
with vapors (westrosol, percloretilene, etc.)
alkali cleaning (soda lye, potassium hydroxide etc.)
acid cleaning (phosphoric acid, hydrogen nitrate, chlorine hydride etc.)
cleaning in salt baths (barium chloride, potassium chloride etc.)

Choosing the dry cleaning agent and the method used depends on the nature of the base metal, the state of the soldering/brazing surface and on the form of the junction. In the case of the example shown, there has been performed a cleaning with organic solvents (acetone). The cleaned pieces have been stored in a space arranged as to avoid the contamination of the surfaces to be jointed.

b) The Cleaning of the Surfaces to be Jointed During the Brazing Process

This operation is necessary because, during the heating process for brazing, on the surfaces of the components are formed oxidic compounds whose nature depends on the type of the base material, the heating temperature, the speed and duration of heating, the working environment etc. For cleaning, mixtures of chemical substances used are called flows which have the purpose of:
dissolving oxides from the soldering/brazing surfaces;
protecting the surfaces during soldering/brazing through the formation of a cover with the melting temperature lower than the soldering/brazing alloy so as to avoid oxidation of the joint surfaces;
ensuring the decrease of the viscosity and of the surface pressure in the interface areas between the soldering/brazing alloy and the surfaces of the junction joint.

In the case of the example shown, the junctions between stainless steel and copper alloys have been pickled with brazing flow AG 8 according to EN 1045, and the junctions between the aluminum components with brazing flow AL 1 according EN 1045, both under the form of a paste. The flux cover has been applied on the soldering surfaces with the aid of a tailpiece.

c) The Positioning of the Assembly in View of Brazing/Soldering

The operation must be developed so as to ensure the correct positioning of the components during the soldering/brazing process, as well as the final geometry of the junction according to the drawing. The control criteria are:
The position of the soldering/brazing surfaces;
The free gap in the junction;
The overlapping length.

In the case of the present example, the brazing position was horizontal in the case of the junctions between flat products, respectively, vertical in the case of junctions between tubular products, the free gap in the junction or the dimension of the brazing gap was r= 0.05-0.12 mm, and the overlapping length of the components was 8 mm.

d) Achievement of Component Brazing

The brazing technique is the one with a flame burner with HHO oxy-hydrogen gas. Depending on the requirements of the work, the operation can be executed manually, powered or automatic. The essential parameters of the operation are:
The filler metal, respectively, the brazing alloy identified through the chemical composition, the mechanical characteristics and, most of all, the melting temperature;
The size of the nozzle of the burner and the pressure of the HHO oxy-hydrogen gas.

In the operation presented, the brazing alloys used were: alloy Ag49MnNi according to SR EN 1044 under the form of a foil with the thickness of 0.3 mm for the junctions between flat products from stainless steel, from silver Ag 99.9 and copper alloy mark CuSn6, alloy AlSi12 according to SR EN 1044 under the form of a rod with sizes Ø2×500 mm for junctions between flat products from aluminum alloys, respectively, alloy Ag 104 according SR EN 1044 under the form of a rod with sizes Ø1.5×500 mm for the junctions between tubular from copper and copper alloys.

In view of starting the brazing process, the HHO oxy-hydrogen gas supply is prepared. In the case of the presented application, the HHO oxy-hydrogen gas was produced by a generator according to U.S. Pat. No. 6,689,259 B1, supplied by a 220 V.a.c. and 40 A source and endowed with pressure controller, as well as with a protection valve STAS 12011/2-89 to prevent flareback. A burner from an implement of low pressure was used, with the nozzle diameter of 1 mm.

The work pressure of the gas was 0.25÷0.26 MPa at pipe brazing Cu99.5/pipe Cu99.5; 0.24÷0.25 MPa at pipe brazing CuZn37/pipe CuZn37 and at pipe brazing CuZn37/pipe Cu99.5; 0.22÷0.23 MPa at brazing stainless steel plate/stainless steel plate; 0.25÷0.26 MPa at pipe brazing Al99.5/pipe Al99.5; 0.24÷0.25 MPa at plate brazing Al99.5/plate Al99.5, respectively, 0.234÷0.24 MPa at brazing contact Ag99.5/band CuSn6.

The components that form the junction get heated in the junction area at the work temperature of the brazing alloy. The orientation of the burner toward the junction area, as well as the distance from the head of the nozzle to the junction surface were correlated with the burning operation so as to ensure the heating of the brazing area at work temperature. The work temperatures (Wt) of the filler metals used were 750° C. for the alloy Ag49MnNi, 670° C. for the Ag104 alloy, 580° C. for the AlSi12 alloy.

During the heating process in view of brazing, the HHO oxy-hydrogen gas flame was preferentially oriented to the brazing surface of the thicker mark. The heating of the components was realized through the swinging of the burner to avoid localized heating. When the work temperature is reached in the junction area, the alloy which constitutes the filler metal melts, and through the phenomenon of capillarity it fills the brazed joint. In this moment, the process of removing the HHO oxy-hydrogen gas flame is initiated.

The cooling is done in still air, in order to protect the junction so as it is not displaced or hit during the solidification and cooling of the brazing alloy.

After brazing, the application of a thermal treatment is not necessary.

Synthetically, the main work parameters used in the presented application are given in Table 1. The aspect of the achieved junctions is seen in FIG. 2.

TABLE 1
Work parameters at brazing the junctions between
different classes of flat and tubular products

| | | Filler materials | Work parameters | |
|---|---|---|---|---|
| Base Materials - BM | | Brazing alloy/ | HHO Gas | Work |
| MB1 | MB 2 | cleaning fluxes | pressure, MPa | temperature, ° C. |
| Pipe Cu 99.5 | Pipe Cu 99.5 | Ag104/Flux AG 8 | 0.25 . . . 0.26 | 670 |
| Ø9 × 1 mm | Ø9 × 1 mm | | | |
| Pipe CuZn37, | Pipe CuZn37, | Ag104/Flux Ag 8 | 0.24 . . . 0.25 | 670 |
| Ø 9 × 1 mm | Ø 12 × 2 mm | | | |
| Pipe Cu | Pipe CuZn37, | Ag104/Flux Ag 8 | 0.24 . . . 0.25 | 670 |
| Ø 9 × 1 mm | Ø 9 × 1 mm | | | |
| Pipe CuZn37, | Pipe CuZn37, | | | 670 |
| Ø 9 × 1 mm | Ø 9 × 1 mm | | | |
| Steel plate | Steel plate | Ag49MnNi/Flux AG 8 | 0.22 . . . 0.23 | 750 |
| Stainless steel | Stainless steel | | | |
| W 1.4301 | W 1.4301 | | | |
| Pipe Al 99.5 | Pipe Al 99.5 | AlSi12/Flux AL 1 | 0.25 . . . 0.26 | 580 |
| Ø 10 × 1.5 mm | Ø 10 × 1.5 mm | | | |
| Plate Al 99.5 | Plate Al 99.5 | AlSi12/ΛlSi12 | 0.24 . . . 0.25 | 580 |
| 1.5 × 10 mm | 1.5 × 10 mm | | | |
| Strap CuSn6, | Contact Ag 99.9 | Ag49MnNi/Flux AG 8 | 0.23 . . . 0.24 | 750 |
| 1 × 6 mm | 1.5 × 6 mm | | | |

Product examining and testing methods using the brazing procedure according to the invention presented in Table 2.

TABLE 2
The schedule for testing the joints with
brazing according to the invention

| Type of examination or test | Number of trials | Technical conditions |
|---|---|---|
| Visual examination | 100% | EN 12799 |
| Tear test | 1 test/joint | EN 12797 |
| Microscopic examination | 1 test/joint | EN 12797 |

As a result of the test made, there were established the following:
at visual examination, there were confirmed the continuity of the filling areas and the lack of shape distortions in relation to the drawing;
at the tear test there was verified the breaking place which was located on the base metal and not in the joining area;
at the microscopic examination there were verified the joining microstructures and the reaction between the base metal and the brazing metal, which were found to be correct, practically no morphological modifications.

### EXAMPLE 2

### Brazing of Ceramic Plates on Steel Base Using the HHO Oxy-Hydrogen Gas Procedure

The procedure according to the invention was applied to brazing of ceramic plates of different shapes and dimensions onto steel base pieces.

The joints by brazing were executed according to the provisions of SR EN 13134 and ASME Code Section IX, using the brazing technique mentioned in example 1 above, with the following specifications:
the ceramic plates and the steel base which were to be soldered together were cleaned in the joining area with an organic solvent;
the joining area was protected with welding flux AG 8 according to SR EN 1045, in a paste form;
the positioning of the components was done by overlapping according to the joining drawing, mentioning that the ceramic plates were positioned horizontally onto the steel base, according to indicative PA of PT CR 7/1-2003;
the ceramic plates were of the following types: SZ 3(73928 with the dimensions 4×7×13 mm; SZ 7/4479 with the dimensions 4×13×21 mm; SZ 5/9851 with the dimensions 4×4.5×10.5 mm; SZ 5/0690 with the dimensions 4×6×10.7 mm; SZ 7/3233 with the dimensions 4×12.5×13 mm;
the base material on which the plates were applied was steel OL 52-4kf according to STAS 500-2, as a profile bar with the following dimensions 4×18×70 mm according to SR EN 10029-93;
the metal added was alloy Ag49MnNi according to SR EN 1044, as a 0.30 mm thick strip;
the dimension of the joint gap was of maximum 0.12 mm;
the working pressure of the HHO oxy-hydrogen gas was of 0.23÷0.24 MPa for brazing the plates SZ 3C/3928; 0.25÷0.26 MPa for brazing the plates SZ 7/4479; 0.24÷0.25 for brazing the plates SZ 7/3233; 0.22÷0.23 for brazing the plates SZ 5/0690, respectively, 0.21÷0.22 Mpa for brazing the plates SZ 5/9851;
the melting temperature for the brazing alloy was of 750° C.; during the heating process for the brazing, the flame of HHO oxy-hydrogen gas was concentrated towards the base material with the oscillating of the burner in order to avoid local heating; when the working temperature was reached in the joining area, namely approximately 750° C., the Ag49MnNi alloy melted, and by the capillary phenomenon filled the joining area, and in that moment the flame of oxy-hydrogen gas was removed;
the assembly was slowly cooled, the joining area was protected so that it was not moved or stroked during the solidifying and the cooling of the brazing alloy;
after the brazing there was no need for a thermo treatment.

The types of joints by welding, material data and the main parameters of the brazing process are presented in table 3. The aspect of the joints achieved using the invention procedure is shown in FIG. 2.

TABLE 3
Working parameters for the environmentally friendly
brazing of ceramic plates onto steel base

| | | Added material | Working parameters | |
|---|---|---|---|---|
| Base material | | Brazing alloy/ | Gas HHO | Working |
| Ceramic plates | Steel | pickling flux | pressure, MPa | temperature, ° C. |
| SZ 3C/3928 | OL 52 - 4 kf | Ag49MnNi/AG 8 | 0.23 . . . 0.24 | 750 |
| 4 × 7 × 13 mm | | | | |
| SZ 7/4479 | OL 52 - 4 kf | Ag49MnNi/AG 8 | 0.25 . . . 0.26 | 750 |
| 4 × 13 × 21 mm | | | | |
| SZ 7/3233 | OL 52 - 4 kf | Ag49MnNi/AG 8 | 0.24 . . . 0.25 | 750 |
| 4 × 12.5 × 13 mm | | | | |
| SZ 5/0690 | OL 52 - 4 kf | Ag49MnNi/AG 8 | 0.22 . . . 0.23 | 750 |
| 4 × 6 × 10.7 mm | | | | |
| SZ 5/9851 | OL 52 - 4 kf | Ag49MnNi/AG 8 | 2.1 . . . 2.2 | 750 |
| 4 × 4.5 × 10.5 mm | | | | |

The testing of the joints was done according to a program similar to the one presented in Table 2 and it led to the following conclusions:
all joints presented a correct appearance, not having discontinuities or distortions;
the breakings at the tearing test were produced in the base material at a stress of min. 246 N/mm² comparatively to min. 100 N/mm² recommended;
microscopically there were no flaws with respect to the continuity and the adherence of the joining material, and no modifications to the microstructure of the base and joint materials;

As a conclusion, the multiple experiments for execution of joints by brazing with HHO oxy-hydrogen gas flame, made according to the U.S. Pat. No. 6,689,259 B1 and the international request published under the no. WO2005076767 A3, shows the capacity of this gas to make joints by brazing metal materials like steel, aluminum, copper, silver and their respective alloys, as well as of nonmetallic materials like synthered ceramic materials.

The main parameters of the procedure of brazing using HHO oxy-hydrogen gas according to the invention are:
base material, metallic and nonmetallic, in any type and dimension;
the soldering/brazing material, as alloy with the melting temperature under 450° C. for soldering and respectively above 450° C. for brazing;
the brazing soldering flux, adapted from the point of view of type and method to the specifications of the joining materials;
the drawing and position of the assembly, for example in vertical or horizontal position, as well as the free gap of the joint, for example of max. 0.12 mm in the applications shown;
the pressure of the HHO oxy-hydrogen gas, for example of 0.21÷0.26 MPa in the applications shown, in the conditions of using a burner from a low pressure kit, with the diameter of the nozzle of 1 mm.

Compared to the brazing flame procedures that use combustible hydrocarbon gases, the procedure according to the invention ensures the executions of the brazing operations totally eliminating the noxious gases emission, reducing the energy consumption for the brazing operation and improving the quality of the joints by eliminating the influence of the temperature on the joint materials.

The procedure according to the invention is used also for covering surfaces of all types by thermo spraying of metal and nonmetal materials.

1.-3. (canceled)

4. A flame soldering/brazing procedure for metallic and nonmetallic materials of any type and dimensions wherein when using said procedure, carbon oxide gas emissions are eliminated and all other noxious gases emissions are substantially reduced and a temperature influence over the joint materials is also substantially reduced, the soldering/brazing procedure comprising:
using a burner with HHO oxy-hydrogen gas at a pressure of 0.1÷0.3 MPa by uniformly heating the overlapping material until the brazing alloy melts.

5. The procedure according to claim 4, wherein when soldering/brazing alloys with silver or aluminum base are used, a joint gap is between 0.03 . . . 0.15 mm.

6. The procedure according to claim 4, wherein for joints with an overlapping length of maximum 10 mm, a diameter of a burner nozzle being used is about 1.0 mm.
